(19) United States
(12) Patent Application Publication
(10) Pub. No.: US 2023/0419542 A1
(43) Pub. Date: Dec. 28, 2023

(54) METHOD FOR CALIBRATING A REAR-VIEW CAMERA, AND VEHICLE

(71) Applicant: ZF CV SYSTEMS GLOBAL GMBH, Bern (CH)

(72) Inventor: Tobias Klinger, Springe (DE)

(21) Appl. No.: 18/253,936

(22) PCT Filed: Nov. 25, 2021
(86) PCT No.: PCT/EP2021/082995

§ 371 Date: May 23, 2023

(30) Foreign Application Priority Data
Dec. 1, 2020 (DE) 10 2020 131 778.6

(51) Int. Cl. G06T 7/80; B60R 1/26; B60R 1/28

(52) U.S. Cl. CPC G06T 7/80; B60R 1/26; B60R 1/28; G06T 2207/30204; G06T 2207/30244; G06T 2207/30252

(57) ABSTRACT

A method for calibrating a rear-view camera on a vehicle, having at least one component which can be adjusted, wherein the at least one component can be adjusted into a calibration setting and at least one marker is arranged on the at least one component such that the marker lies in an acquisition region of the rear-view camera after the at least one component has been adjusted into the calibration setting. The rear-view camera is in a camera pose relative to the vehicle, and the method includes reading in image signals of the rear-view camera, reading in at least one marker position, ascertaining at least one image position as a function of the image signals and calibrating the rear-view camera as a function of the read at least one marker position of a respective marker and the ascertained image position of the respective marker.

### CROSS REFERENCE TO RELATED APPLICATIONS

This application is a U.S. National Phase application under 35 U.S.C. § 371 of International Application No. PCT/EP2021/082995, filed on Nov. 25, 2021, and claims benefit to German Patent Application No. DE 10 2020 131 778.6, filed on Dec. 1, 2020. The International Application was published in German on Jun. 9, 2022 as WO 2022/117432 A1 under PCT Article 21(2).

### FIELD

The invention relates to a method for calibrating a rear-view camera and to a vehicle, in particular a utility vehicle, having a rear-view camera for carrying out the method.

### BACKGROUND

Vehicles, in particular utility vehicles, with a driver assistance system may have various sensors depending on the application, for example cameras or camera systems, with which the environment around the vehicle can be captured in a fixed acquisition region. The image data generated in the camera system, which characterize the captured environment, may then be used to evaluate the current driving situation. So that this can be done reliably, the camera system, or the acquisition region thereof, needs to be aimed accordingly in order to be able to capture the desired environment.

Previous camera systems that are employed in the field of driver assistance systems are either installed in a fixed fashion in the respective vehicle at the factory, so that defective aiming of the camera can be virtually ruled out, or the camera systems, especially retrofit solutions, are used only to display an image but not for an automated driving maneuver, so that defective aiming would not be serious.

Rear-view cameras in particular, for example on towing vehicles, trailers or semitrailers, which are used in the scope of reversing assistance, need to be precisely calibrated in order to ensure the functionality of the driver assistance system as a whole. Rear-view cameras are cameras that are aimed at a rear space behind the vehicle, this being required for example for reversing assistance. The greatest possible accuracy for the detection of objects in the rear space can be achieved only if the rear-view cameras are calibrated properly and their aim also does not change over time. If the calibration is defective, for instance due to unintentional rotation of the camera, detection errors may occur, which in connection with automated driving may lead to undesired maloperation of safety mechanisms.

Auto-calibration of sensors is common practice, for example, for radar systems. For camera systems, this step is somewhat more complicated since distances (for example to the ground plane) cannot be measured directly and it is therefore necessary to resort to relatively complex algorithms in order, for instance, to identify a reference object (such as the ground plane or the vehicle itself). Especially in the case of retrofit systems and in the case of component parts protruding from the vehicle, the risk of unintentional displacement or rotation of the camera exists since the camera is not inherently connected to the vehicle.

EP 2 237 224 B1 describes a method for calibrating a camera by means of markers. The markers are in this case applied outside the vehicle and the system is intended to be set manually. EP 2 416 558 A1 and EP 3 125 196 B1 also describe markers for setting a camera on the vehicle, the markers being located outside the vehicle. Such calibrations are elaborate and can only be carried out location-dependently, a particular driving maneuver also having to be carried out for the calibration.

In category M, N vehicles, driver assistance systems with a rear-view camera are required because of a changing legal framework. This may also be extended in the future to category O. For such vehicles, it is therefore necessary to ensure secure and reliable calibration of the respective rear-view cameras. Such vehicles may furthermore have deployable attachments to improve the aerodynamics, such aerodynamic attachments or air guide components being described for example in US 2016/304137A1, U.S. Pat. No. 7,008,005 A1, EP 3 013 671 A1 and US 2016/318559A1.

### SUMMARY

In an embodiment, the present disclosure provides a method for calibrating a rear-view camera on a vehicle, having at least one component which can be adjusted, wherein the at least one component can be adjusted into a calibration setting and at least one marker is arranged on the at least one component such that the marker lies in an acquisition region of the rear-view camera after the at least one component has been adjusted into the calibration setting. The rear-view camera is in a camera pose relative to the vehicle, and the method comprises reading in image signals of the rear-view camera, the acquisition region of the rear-view camera being aimed at a rear space behind the vehicle such that the read image signals characterize an image of the rear space behind the vehicle, while the at least one component is in the calibration setting. The method also comprises reading in at least one marker position, each read marker position being assigned to a respective marker of the at least one marker on a respective component of the at least one component, while the respective component is in the calibration setting, and ascertaining at least one image position as a function of the image signals, each ascertained image position being assigned to a respective marker on the respective component, while the respective component is in the calibration setting. The method further comprises calibrating the rear-view camera as a function of the read at least one marker position of a respective marker and the ascertained image position of the respective marker.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a vehicle having a rear-view camera and a calibrating arrangement according to an embodiment of the invention;

FIGS. 2a and 2b show images of a camera in different settings of the calibrating arrangement according to an embodiment of the invention; and

FIG. 3 shows a flowchart of a method according to an embodiment of the invention.

### DETAILED DESCRIPTION

In an embodiment, the present invention provides a method for calibrating a rear-view camera, with which simple and reliable aiming of a rear-view camera can be ensured in any driving situations. In an embodiment of the invention, a vehicle is provided.

According to an embodiment of the invention, a method is accordingly provided for calibrating a rear-view camera on a vehicle, that is to say a camera which is aimed at a rear space behind the vehicle. The rear-view camera is in this case in a particular camera pose relative to the vehicle, the camera pose being specified by an orientation of the camera in preferably three rotational degrees of freedom and a position of the camera in preferably three translational degrees of freedom, for example in a vehicle-referenced coordinate system or in an arbitrary world coordinate system.

The vehicle comprises at least one component (adjustable component) which can be adjusted, in particular deployed or extended, for example an air guide component, in particular an upper and/or lateral air guide flap. The at least one component can be adjusted into at least one calibration setting, and at least one marker is arranged on the at least one component in such a way that the marker lies in an acquisition region of the rear-view camera after the at least one component has been adjusted into the at least one calibration setting. A marker is in this case intended to mean for example a two-dimensional, that is to say round or angled or cruciform, structure, which may be one-colored or multi-colored and which can also be identified uniquely by the camera as a defined structure on the respective component.

A component which can be adjusted is in this case intended to mean a component that is connected to the vehicle and can be adjusted in relation to the vehicle, for example deployed, pivoted, moved, etc. In particular, an air guide component is intended to mean a component on the vehicle with which a particular air guiding function can be achieved, the air flow around the vehicle, in particular the rear, being deviated when the air guide components are extended, or deployed, so that more uniform and more efficient driving is made possible and fuel savings can be achieved at high vehicle speeds, for example >60 km/h.

After a calibrating mode has been activated, or optionally a check has been made as to whether a calibrating mode is activated, and when appropriate it has been ascertained whether the at least one component, for example an air guide component, is in the calibration setting, at least the following steps are carried out in the method according to an embodiment of the invention:
reading in image signals of the rear-view camera, the acquisition region of the rear-view camera being aimed at a rear space behind the vehicle in such a way that the read image signals characterize an image of the rear space behind the vehicle, while the at least one component is in the calibration setting;
reading in at least one marker position, each read marker position being assigned to a marker on the respective component, while the respective component is in the calibration setting;
ascertaining at least one image position with the aid or as a function of the image signals, or with the aid of the image of the rear space behind the vehicle, each ascertained image position being assigned to a marker on the respective component, while the respective component is in the calibration setting;
calibrating the rear-view camera as a function of the read marker position of a marker and the ascertained image position of the same marker.

The effect advantageously achieved by this method is that the adjustable components connected directly to the vehicle can be brought purposely into the calibration setting in order in this way to be able to carry out a calibration of the camera independently of the location, in a fully automated fashion and with little effort. A further advantage is that the air guide components present on the vehicle, which need to be in the acquisition region of the rear-view camera anyway, at least in certain driving situations, for example at higher vehicle speeds, may be used as adjustable components for the calibration of the rear-view camera. Advantageously, the air guide components are generally always retracted—that is to say not in the way—at low vehicle speeds, at which the rear-view camera is employed, and they are deployed at high vehicle speeds, at which the rear-view camera is generally not used. In these driving situations, in which the air guide components are deployed or extended anyway in order to fulfill the respective air guiding function, the marker applied on them may be used straightforwardly for an automated calibration. The air guide components may therefore advantageously fulfill a twofold function.

A calibration of the rear-view camera is in this case intended to mean that it is possible to find a rule, for example a geometrical rule, or geometrical features of the existing system, with which an image position of a marker, which has been ascertained from the image signals, can be transposed as exactly as possible to the real situation, or scene. In this way, an object identified in the environment by the camera can be localized uniquely relative to the vehicle, for example for use in an assistance function.

Since the marker position of a marker on the respective component for the respective calibration setting can readily be learnt, or established, the calibration may straightforwardly be carried out in an automated fashion from geometrical considerations by means of the acquired image position of a marker from the captured image. Special driving maneuvers are therefore not necessary in order to calibrate the rear-view camera, and manual interventions are not necessary for the calibration. The calibration method may therefore be carried out independently of the location, in a fully automated fashion and with little effort.

Preferably, a transformation matrix as a “geometrical rule” and/or the camera pose of the rear-view camera (for example relative to the vehicle) is in this case ascertained from the marker position read in for a marker and the ascertained image position of the same marker, in such a way that the image position of a marker is transformed by means of the transformation matrix and/or as a function of the camera pose onto the read marker position, or transposed by geometrical considerations. A calibration may therefore be carried out straightforwardly by corresponding mathematical methods, or by geometrical considerations.

Preferably, for this purpose, the ascertained image position of a marker may be specified in image coordinates and the image coordinates of a marker may be transformed as a function of the ascertained transformation matrix and/or the ascertained camera pose into transformed image coordinates in a cartesian coordinate system, preferably a vehicle-referenced cartesian coordinate system or a vehicle-independent world coordinate system, the marker position of the same marker preferably likewise being specified in the cartesian coordinate system. In this way, a simple transformation may be applied, and this may also be employed in the subsequently used assistance function.

Preferably, furthermore, a deviation between the ascertained camera pose of the rear-view camera and a prespecified camera setpoint pose is ascertained and the rear-view camera is aligned in such a way that the deviation is reduced if a fixed limit value for the deviation is exceeded, the deviation preferably being compensated for.

By means of the read marker position of a marker and the ascertained image position of the same marker, not only is it thus possible to ascertain or estimate the current camera pose (when appropriate by means of the transformation matrix), but an excessive deviation may also be recognized. In order to ensure reliable use of the calibrated camera for a corresponding assistance function in that case as well, a corresponding correction of the camera pose, or an alignment, may subsequently be carried out, this preferably being done before the calibration of the rear-view camera in order subsequently to be able to employ the image signal of an aligned and calibrated camera.

Preferably, for this purpose, the rear-view camera is adjusted if the limit value is exceeded in order to make the ascertained camera pose approach the camera setpoint pose, an alignment signal being generated and output for this purpose as a function of the ascertained deviation between the ascertained camera pose of the rear-view camera and a prespecified camera setpoint pose, a camera actuator that cooperates with the rear-view camera being actuated with the alignment signal in such a way that the camera pose of the rear-view camera is adjusted. Fully automated alignment may be made possible in this way. In principle, however, the alignment may also be carried out manually or in a semiautomated fashion.

Furthermore, for full or partial automation, the at least one component, for example an air guide component, with the at least one marker can in particular be aligned in an automated fashion, for example by means of a component actuator.

Preferably, furthermore, at least two components, for example air guide components, are provided in this case, for example left and right or lateral and upper, the at least two components being brought together or individually, that is to say also independently of one another, into the calibration setting for the calibration of the rear-view camera. In this way, it is possible to avoid individual components entering the acquisition region of the rear-view camera during activation of the calibrating mode even though it is currently used for some assistance function. If calibration is required at the same time as this, it may be carried out by means of one or more components that are not obscuring the view of the rear-view camera in a region relevant for the application in question.

Preferably, furthermore, the at least one component, for example an air guide component, can be adjusted continuously or in stages between a first end setting and a second end setting, the at least one component in the calibration setting being in an intermediate setting between the first end setting and the second end setting, or in the first end setting, or in the second end setting.

In this way, the flexibility may be increased since the respective component can be brought into an intermediate setting, when appropriate independently of other components. In the case of an air guide component, it can still fulfill its air guiding function in the intermediate setting but, at the same time, also contribute to the calibration function and not interfere with the driver assistance in question.

Preferably, furthermore, the at least one component, for example an air guide component, can be brought into different calibration settings, each marker on this at least one component in this case being assigned a plurality of marker positions, each marker position of the respective marker being assigned to one of the different calibration settings so that the calibration of the rear-view camera can be carried out as a function of the read marker position of a marker for the respectively set calibration setting and the ascertained image position of the same marker.

The flexibility may be increased further in this way, since different calibration settings are also possible for a component, and the calibration may also be plausibilized by setting different calibration settings, for example in unfavorable light conditions or in the event of fouling. In addition thereto, and for the other configurations described, the deviation recognized may also be plausibilized with the aid of different markers on different components before a calibration.

Preferably, furthermore, before image signals of the rear-view camera are read in, the at least one component may be brought automatically into the calibration setting as soon as the calibrating mode is activated, for example by means of the component actuator, or waiting is carried out until the at least one component is brought into the calibration setting in another way, the component in the case of an air guide component being for example adjusted into the calibration setting in an automated fashion as a function of a vehicle speed of the vehicle, for example at vehicle speeds of more than 60 km/h, in order to achieve an air guiding function. In this way, after an activation of the calibrating mode, in one variant waiting may be carried out until, for example, the air guiding function in the vehicle is activated in another way and the air guide components are thereupon brought automatically into the calibration setting, which may then for example correspond to the deployed or extended end setting. On the other hand, active adjusting of the respective component may also be provided, in the case of an air guide component the setting based on the air guiding function then also being overridden when appropriate, for example when a calibration is absolutely necessary.

An embodiment of the invention furthermore provides a vehicle, in particular a utility vehicle, having a calibrating arrangement and a rear-view camera, wherein the rear-view camera is in a camera pose relative to the vehicle, wherein the calibrating arrangement comprises:
a processing unit, which is configured to carry out the method according to an embodiment of the invention for calibrating the rear-view camera, and
at least one adjustable component, for example an air guide component, the at least one component being capable of being adjusted into a calibration setting and at least one marker being arranged on the at least one component in such a way that the marker lies in an acquisition region of the rear-view camera when the at least one component is adjusted into the calibration setting, the acquisition region of the rear-view camera being aimed at a rear space behind the vehicle. The method may therefore be carried out in a vehicle, for example of category M, N or O, in which a rear-view camera is normally arranged, or the arrangement thereof is very likely in the future, and which therefore also needs to be calibrated.

Preferably, in this case, the vehicle comprises a single section, in particular consisting of a motor vehicle, or comprises multiple sections, in particular consisting of a tractor and a semitrailer, or similarly thereto a motor vehicle with at least one (drawbar) trailer.

Preferably, furthermore, the rear-view camera is arranged on a semitrailer rear of the semitrailer and/or on a tractor rear of the tractor or on a motor vehicle rear of the motor vehicle. In this way, monitoring of the rear space may be achieved from different positions that are also available for calibration with the aid of the components, for example air guide components.

Preferably, furthermore, the vehicle comprises a driver assistance system, for example reversing assistance, the driver assistance system being configured to read in and process the image signals of the calibrated rear-view camera, that is to say for example with the aid of the respective ascertained transformation matrix and/or the ascertained camera pose.

Embodiments of the invention will be explained in more detail below with the aid of an exemplary embodiment.

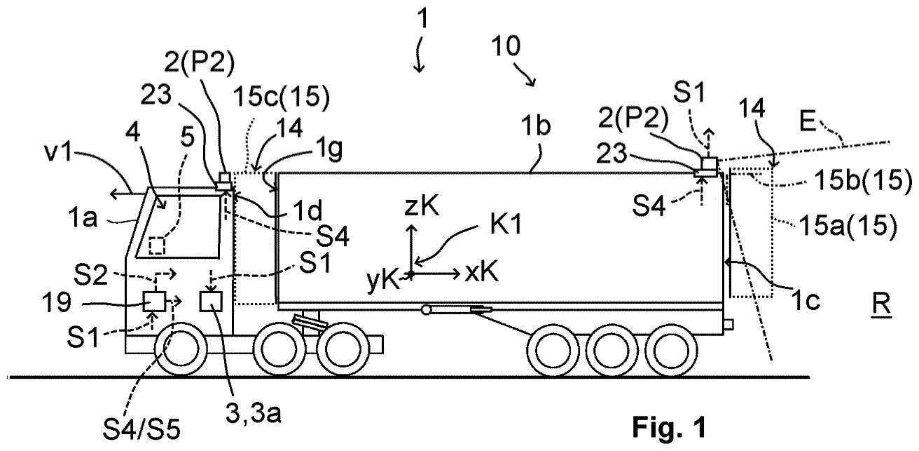

The system described below may in principle be used with a vehicle 1 comprising a single section, for example a motor vehicle 1e, or with a vehicle 1 comprising two or more sections, for example a motor vehicle 1e with at least one trailer or a tractor-trailer rig with at least one semitrailer 1b. By way of example, an embodiment of the invention will be described below with the aid of the two-section tractor-trailer rig (tractor 1a, semitrailer 1b) schematically represented in FIG. 1, a rear-view camera 2 being located in the region of a semitrailer rear 1c on the semitrailer 1b. In the case of a motor vehicle 1e, the rear-view camera 2a is correspondingly arranged, for example, on a motor vehicle rear 1f.

The rear-view camera 2 has an acquisition region E, which is aimed at least at a rear space R behind the vehicle 1, or behind the semitrailer 1b. In addition or alternatively, a rear-view camera 2 in the tractor-trailer rig according to FIG. 1 may also be provided in the region of a tractor rear 1d of the tractor 1a. This rear-view camera 2 likewise has the property that its acquisition region E is aimed at least at the rear space R behind the vehicle 1. There may also be more than one rear-view camera 2 on the respective rear 1c, 1d. In the case of a single-section vehicle 1, the rear space R is correspondingly located on the rear side behind the motor vehicle 1e with corresponding aiming of the rear-view camera 2 arranged thereon.

The rear-view camera 2 is assigned a camera pose P2, the camera pose P2 being provided by an orientation (given by three rotational degrees of freedom) and a position (given by three translational degrees of freedom) of the camera 2 in a fixed coordinate system. The camera pose P2 may in this case be specified for example in an arbitrary vehicle-referenced coordinate system K1 with cartesian coordinates xK, yK, zK. In principle, however, any other vehicle-(in)dependent coordinate system may be selected as the coordinate system.

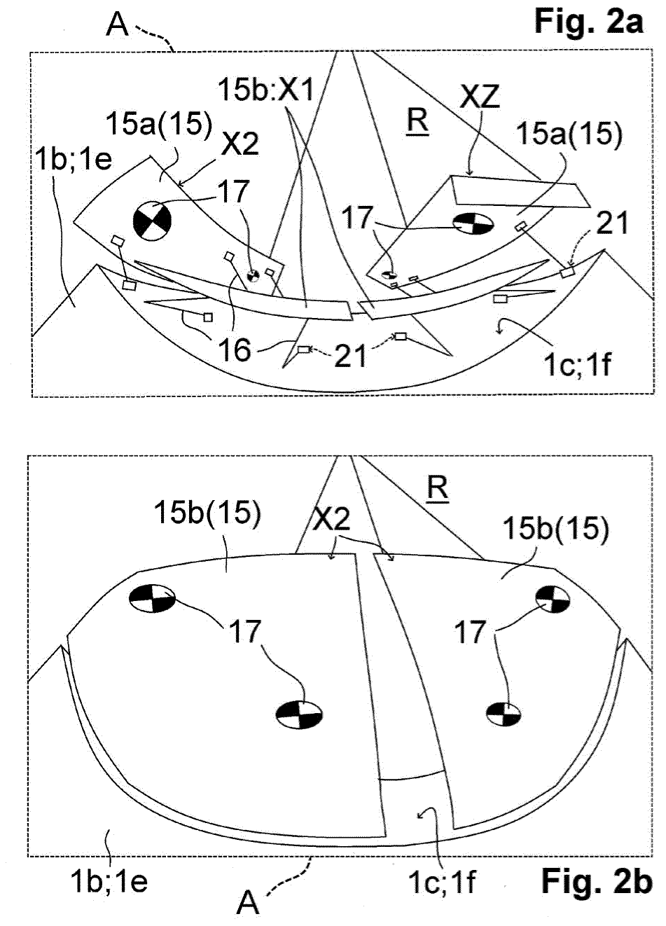

The rear-view camera 2 is connected to a driver assistance system 3 in any desired way, or is a part thereof, the driver assistance system 3 being for example configured to carry out an automated driving maneuver, in particular a rearward driving maneuver, as a function of image signals S1 which are output by the respective rear-view camera 2. The driver assistance system 3 may, however, also be configured to generate overlay signals S2, which for example contain a driving path, with the aid of the image signals S1 in order to assist the driver with a display of the overlay signals S2 as a supplement or extension of the image signals S1 on a monitor 5. The image signals S1 in this case transmit an image A of the rear space R behind the vehicle, or the rear space R may be extracted from the image signals S1 for further processing. Images A of the rear-view camera 2 on the semitrailer rear 1c are represented by way of example in FIGS. 2a, 2b. In principle, however, a similar image A is also obtained when the rear-view camera 2 is arranged on the motor vehicle rear 1f of the motor vehicle 1e.

As a function of the image signals S1 of the respective rear-view camera 2, the driver assistance system 3, which for example comprises reversing assistance 3a, may assist the driver in the known way during reversing or may carry out the reversing in an automated fashion. For this purpose, for example, the monitor 5 may be arranged in a passenger compartment 4 of the tractor 1a in order to visually represent to the driver the image A extracted from the image signals S1, when appropriate supplemented with the overlay signals S2, for example a driving path or the like.

In order to be able to carry out any assistance functions reliably, it is necessary to transpose an object acquired by the rear-view camera 2, which is described in the image A or in the image signal S1 by means of corresponding image coordinates xA, xB, into the vehicle-referenced coordinate system K1 (or an arbitrary world coordinate system). The transposition or transformation is carried out, for example, by means of a transformation matrix T which transforms the ascertained image coordinates xA, xB of the respectively acquired object into the vehicle-referenced coordinate system K1 (or into the world coordinate system). For this purpose, image coordinates Xt, Yt, Zt transformed from the image coordinates xA, xB by means of the transformation matrix T are ascertained, for example in the vehicle-referenced coordinate system K1.

With the aid of the transformation matrix T, the location of the acquired object in relation to the vehicle 1 can thus be determined uniquely, and reaction or assistance corresponding thereto may be carried out. The transformation matrix T is in this case dependent on the camera pose P2, that is to say the location of the camera 2 on the vehicle 1, or in space. The transformation matrix T is for example a 3×4 matrix, which is composed of a 3×1 translation vector and a 3×3 rotation matrix, and which is therefore similar to the camera pose 2 (three translational and three rotational degrees of freedom).

Since the transformation matrix T, or the camera pose P2, is not always uniquely known, calibration of the rear-view camera 2 is necessary, for example after installation of the rear-view camera 2. By the calibration, a transformation matrix T applicable for the current situation, or similarly (see above) the camera pose P2, is ascertained. Since the rear-view camera 2 may also be adjusted during operation of the vehicle 1, such calibration is advisable at regular intervals in order to be able to react to a possibly changed camera pose P2. Accordingly, a currently applicable transformation matrix T (or the consequent camera pose P2), which may subsequently be employed for the respective assistance function, is ascertained continuously or at fixed time intervals.

In order to be able to calibrate the respective rear-view camera 2 continuously after installation as well, and optionally aim the acquisition region E in a subsequent alignment optimally at the rear space R, the vehicle 1 comprises a calibrating arrangement 10 which, according to an embodiment of the invention, consists of at least one component 14, which is adjustable in its position on the vehicle 1, and at least one marker 17 applied on the surface of the latter, for example in the form of a two-dimensional round and two-colored (black, white) measurement mark. The two-dimensional marker 17 may however also be polygonal, cruciform or in any other desired shape and color.

An embodiment of the invention will be described below with reference to an adjustable air guide component 15, for example a lateral air guide flap 15a and/or an upper air guide flap 15b, as the component 14 which is adjustable. In principle, other adjustable, for example deployable or extendable, components 14 may however also be envisioned, which are connected to the vehicle 1 in any desired way and which are present only for the calibration of the camera 2 or also for further functions. The functions relating to the calibration which are described below then also apply correspondingly for such components 14.

The at least one air guide component 15 of the calibrating arrangement 10 is located as described below between the respective rear-view camera 2 and the rear space R, so that parts of the at least one air guide component 15, in particular the markers 17, can be acquired by the rear-view camera 2 at least situationally, that is to say at least in the predetermined settings X of the respective air guide component 15.

The air guide component 15 is for this purpose adjustable continuously or in stages between a first end setting X1 and a second end setting X2, in which case the adjusting may be carried out by pivoting or folding (retracting/deploying) or by displacing or moving (withdrawing/extending) the air guide component 15. Pivoting of the air guide components 15 by means of adjustable pivot arms 16 is represented by way of example in the figures. A particular air guiding function can be achieved by the different settings X of the air guide components 15, the air flow being deviated around the vehicle 1, in particular the respective rear 1c, 1d, when the air guide components 15 are extended, or deployed (here: second end setting X2), so that more uniform and more efficient driving is made possible and fuel savings can be achieved at high vehicle speeds v1, for example >60 km/h. Conversely, when the air guide components 15 are withdrawn or retracted (here: first end setting X1), this air guiding function is not enabled, which is preferably the case at low vehicle speeds v1. Depending on the configuration of the air guide components 15, there may in principle also be further intermediate settings XZ in which the respective air guide component 15 can be fixed, between the two end settings X1, X2 mentioned.

The markers 17 are applied on the respective adjustable air guide component 15 in such a way that the markers 17 lie in the acquisition region E of the camera 2 in at least one of the settings X of the air guide component 15, that is to say in at least one fixed calibration setting XK. In this case, the at least one fixed calibration setting XK of the relevant air guide component 15 is or can be set in a calibrating mode M, that is to say when a calibration of the rear-view camera 2 is intended.

It is in this case necessary above all to ensure that the movable vehicle component 15 with the marker 17 obscures the relevant region of the rear space R in the calibrating mode M, or in the at least one fixed calibration setting XK, only when capture of the rear space R with the largest possible area is not currently intended to be carried out for the respective assistance function, for example the reversing assistance 3a. In the calibrating mode M, the respective assistance function should thus as far as possible not be interfered with by the setting X of the air guide component 15.

This is the case in the variant in FIGS. 2a, 2b for the air guide components 15 on the semitrailer rear 1c when the air guide components 15 are in the second end setting X2 (fully extended, deployed) and for example reversing assistance 3a is intended, so that the second end setting X2 can be set as the calibration setting XK in the calibrating mode M. In this second end setting X2, the markers 17 applied on the surface can be identified well by the rear-view camera 2, the distorted representation in FIG. 2a, 2b resulting from the configuration of the rear-view camera 2 as a so-called fisheye camera. Furthermore, the air guide components 15 are normally brought into this second end setting X2 only at high vehicle speeds v1. For reversing assistance 3a, however, the rear-view camera 2 is only used at low vehicle speeds v1, at which the air guide components 15 are adjusted into the first end setting X1 and therefore no longer obscure the relevant region of the rear space R for the reversing assistance 3a.

In addition, it is also possible that not all air guide components 15 of the calibrating arrangement 10 may be used for a calibration of the rear-view camera 2, depending on the application or assistance function. If the rear space R is for example monitored by the assistance function only in the left region, when the calibrating mode M is activated only the air guide components 15 on the right side (right lateral and/or upper air guide flaps 15a, 15b) may be brought into the respective calibration setting XK, in order not to obscure the left region of the acquisition region E of the camera 2. In addition, for some or all air guide components 15, intermediate settings XZ between the two end settings X1, X2 may also purposely be selected as calibration setting XK as a function of the driving situation, so long as the calibrating arrangement 10 with the air guide components 15 allows these intermediate settings XZ to be set. In this case, however, for the subsequent calibration it is helpful if the position of the respective air guide component 15 in the respective intermediate setting XZ can be identified uniquely, in order to be able to deduce an exact marker position PM17 of the markers 17 on the respective air guide component 15 therefrom.

In addition, as represented in FIG. 2a, it may also be possible for only the lateral air guide flaps 15a (one or both) to be brought into their respective calibration settings XK, and for the upper air guide flaps 15b to remain in their first end settings X1 (retracted), in order to be able to acquire the rear space R at least partially during a calibration. This may for example be the case during an assistance function in which the rear-view camera 2 is needed when driving at higher vehicle speeds v1 (monitoring the surroundings) and calibration of the rear-view camera 2 is simultaneously intended to be carried out. In this case, the upper air guide flaps 15b are not automatically brought into the second end setting X2 at higher vehicle speeds v1>60 km/h, but only the lateral air guide flaps 15a (one or both) are. Accordingly, the air guide components 15 may situationally also be brought independently of one another into their calibration setting XK (second end setting X2 or intermediate setting XZ) when the calibrating mode M is activated.

In principle, in the calibrating mode M, the first end setting X1 (retracted, withdrawn) of the respective air guide component 15 may also be set as a calibration setting XK if the markers 17 are positioned on the air guide components 15 in such a way that they can be acquired securely and reliably by the rear-view camera 2 when the calibrating mode M is activated. Usually, however, the air guide components 15 are retracted or withdrawn so far in the first end setting X1 that the markers 17 cannot be perceived fully or uniquely and/or owing to a low brightness can be perceived only with difficulty.

If the rear-view camera 2 is located on the tractor rear 1c, air guide components 15, which lie between the camera 2 and the rear space R as a constituent part of the calibrating arrangement 10, may be located for example on a tail 1d of the semitrailer 1b. Such tail air guide flaps 15c may, with a corresponding configuration, also be adjusted into a first end setting X1 (withdrawn, retracted) and into a second end setting X2 (extended, deployed). Accordingly, a calibration of the rear-view camera 2 may also be carried out with them, in which case, depending on the position of the rear-view camera 2, a calibration setting XK of the respective tail air guide components 15c in the calibrating mode M needs to be selected in such a way that good visibility of the markers 17 is ensured. This is the case for example in a first end setting X1, in which the tail air guide components 15c are approximately parallel or at an acute angle with respect to the tail 1g of the semitrailer 1b and can therefore be perceived reliably by the rear-view camera 2 for a calibration.

For a calibration of the rear-view camera 2, the calibrating arrangement 10 furthermore comprises a processing unit 19. The processing unit 19 is configured to capture and evaluate the image signals S1 of the rear-view camera 2, in which case an image position PB17 of an acquired marker 17 on the air guide components 15 may in particular be ascertained from the image signals S1. Furthermore, the processing unit 19 is configured to read in the marker position PM17 of a marker 17 on an air guide component 15 at least for the calibration setting XK.

The marker position PM17 of a marker 17 in this case indicates where the respective marker 17 is positioned on the vehicle 1 or in the vehicle-referenced coordinate system K1, in the setting X in question of the air guide component 15, preferably in the calibration setting XK, in which case the marker position PM17 may be stored readably for each marker 17 on any desired storage unit in the vehicle. The marker positions PM17 of the markers 17 are for this purpose preferably indicated by marker coordinates x17, y17, z17 in the vehicle-referenced coordinate system K1, by means of which the camera pose P2 is also given.

The image position PB17 of an acquired marker 17 is indicated by image coordinates xA, xB in the image A, that is to say the position at which the respective marker 17 is captured by the rear-view camera 2 in the current camera pose P2 and represented in the image A. The image position PB17 may in this case be ascertained from the image signals S1.

Furthermore, the processing unit 19 may be able to acquire and/or also actively set or influence a setting X of the air guide components 15 of the calibrating arrangement 10. With a corresponding configuration of the rear-view camera 2, the processing unit 19 is furthermore configured to cause a change of the camera pose P2, for example to rotate the rear-view camera 2, in order to realign it in a fixed setting.

The processing unit 19 may in this case be provided as an independent unit merely as a constituent part of the calibrating arrangement 10, or as a constituent part of the driver assistance system 3 or of the rear-view camera 2, or of any other system in the vehicle. The processing unit 19 may in this case be in the form of hardware (extension) or in the form of software, or a computer program product which is installed on a corresponding system.

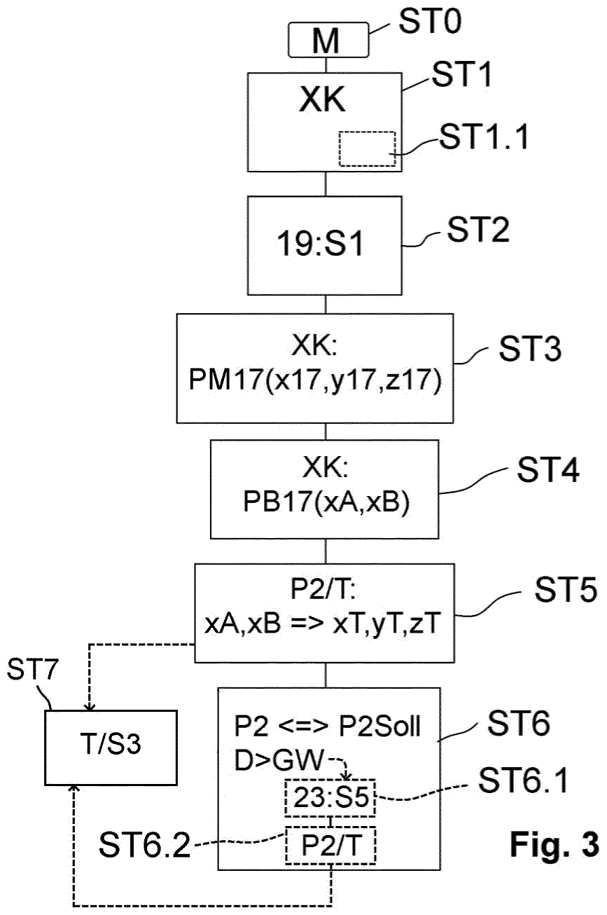

With this described structure, according to FIG. 3 the following method for calibrating the rear-view camera 2 may for example be carried out in the processing unit 19:

In an initial step ST0, a check is first made by the processing unit 19 as to whether a calibrating mode M has been activated, or the calibrating mode M is activated. This may be carried out at fixed time intervals or as a result of an active instruction to calibrate the rear-view camera 2, or to check its calibration. In addition, the calibrating mode M may also be activated automatically when the air guide components 15 of the calibrating arrangement 10 are currently in the calibration setting XK anyway.

In a first step ST1, when the calibrating mode M is activated, it is ascertained whether at least one of the air guide components 15 on the vehicle 1 is in a calibration setting XK. If this is not the case, in an intermediate step ST1.1 either waiting is carried out until at least one of the air guide components 15 has been adjusted by an arbitrary system in the vehicle 1 into the calibration setting XK, or an adjusting signal S4 is generated and output, as a function of which at least one of the air guide components 15 is brought by means of any desired component actuator 21 into the calibration setting XK. In the first variant, for example, waiting may be carried out until there is a vehicle speed v1 at which the air guide components 15 are normally brought automatically into the second end setting X2 as a calibration setting XK. In the second variant, purposeful adjusting of one or more of the air guide components 15 may be carried out, as described in particular with reference to FIGS. 2a and 2b.

In a second step ST2, the rear space R is acquired with the rear-view camera 2 and the captured image signals S1 are read in by the processing unit 19. This is carried out in particular whenever at least one of the air guide components 15 is in the respective calibration setting XK.

In a third step ST3, one or more marker positions PM17 is/are read in by the processing unit 19, each marker position PM17 being assigned a marker 17 on the respective air guide component 15. At the same time, each marker position PM17 of a marker 17 is assigned a calibration setting XK of the respective air guide component 15. From this, it is possible to deduce the marker position PM17 at which the respective marker 17 is located in space or in the vehicle-referenced coordinate system K1 (or in the fixed world coordinate system) for a particular set calibration setting XK.

In a fourth step ST4, one or more image positions PB17 is/are ascertained by the processing unit 19 with the aid of the image signals S1, or the image A of the rear space R, each image position PB17 being assigned a marker 17 on the respective air guide component 15.

Consequently, after the steps ST3 and ST4, which may also be carried out in a different order, each acquired marker 17 is assigned both an image position PB17 and a marker position PM17. If the camera pose P2 has not changed since the last calibration, a transformation matrix T previously assigned to the camera pose P2 should transform the image position PB17 of an acquired marker 17 almost exactly onto the marker position PM17 in the cartesian coordinate system K1. The marker coordinates x17, y17, z17 of a marker 17 should thus in that case correspond approximately to the transformed image coordinates xT, yT, zT of the same marker 17.

In order to avoid errors in such a transformation of the image coordinates xA, xB into the vehicle-referenced coordinate system K1 in the event of (un)intentional adjusting of the camera 2, however, recalibration is provided in a fifth step ST5.

For this purpose, the processing unit 19 is configured to ascertain a current transformation matrix T (or directly the camera pose P2 related thereto) from the ascertained image position PB17 of an acquired marker 17 and the read marker position PM17 of the same marker 17 for the current situation, that is to say for the currently existing camera pose P2, and thereby to calibrate the rear-view camera 2. For the current situation, this transformation matrix T then indicates the geometrical rule according to which the image position PB17 of an imaged marker 17 is to be transposed into the vehicle-referenced coordinate system K1. If the camera pose P2 has not changed since the last calibration, this transformation matrix T will correspond to the previously stored transformation matrix T. Thus, the calibration then remains unchanged.

If the respective air guide component 15 can be brought into different calibration settings XK between the two end settings X1, X2, this needs to be taken into account when reading in both the marker position PM17 in step ST3 and the image position PB17 in step ST4. In this case, particularly when ascertaining the image position PB17, it is necessary to ascertain whether the respective air guide component 15 is actually in the respective calibration setting XK already (see step ST1), which may be done by a return message from the respective component actuator 21 or by an image processing method in which, for example, it is recognized with the aid of the image signals S1 whether the respective air guide component 15 is still moving.

In order also to quantitatively ascertain an adjustment of the rear-view camera 2, or a change of the camera pose P2, in a sixth step ST6 a current camera pose P2 in the vehicle-referenced coordinate system K1 may be estimated from the transformation matrix T ascertained in the fifth step ST5, and this may be compared with a previously specified camera setpoint pose P2Soll. If a deviation D which exceeds a previously defined limit value GW is found between the current camera pose P2 and the camera setpoint pose P2Soll, an alignment of the rear-view camera 2 may be provided.

In principle, an excessive deviation from the camera setpoint pose P2Soll may however also be recognized in a different way in step ST6, for example by checking whether the rear space R or a prespecified number of markers 17 lies at the focus of the camera 2.

By the subsequent alignment, the rear-view camera 2 may be adjusted into a camera pose P2 which approximates the camera setpoint pose P2Soll, in order to compensate fully or substantially for a recognized deviation D and to align the rear-view camera 2 correctly at the rear space R again. For this purpose, in a first substep ST6.1, the camera pose P2 of the rear-view camera 2 on the vehicle 1 may be actively adjusted, for example by means of a camera actuator 23. The latter is configured to pivot or adjust the rear-view camera 2. The processing unit 19 may for this purpose, for example, generate an alignment signal S5 and thereby actuate the camera actuator 23 in order to compensate for the recognized deviation D. This may be done by single purposeful driving as a function of the exactly determined deviation D, or by a control loop.

In a second substep ST6.2, a transformation matrix T and/or the camera pose P2 are subsequently determined for the newly aligned camera 2 according to the principles described above, in order to calibrate the camera 2 correspondingly so that the respective driver assistance system 3 is capable of transforming the image coordinates xA, xB of an acquired object into the vehicle-referenced coordinate system K1 for this newly aligned camera pose P2.

In a seventh step ST7, the transformation matrix T ascertained in the fifth step ST5 and/or the transformation matrix T ascertained in the second substep ST6.2 may then be stored and/or output by means of a calibration signal S3, for example to the driver assistance system 3. With this transformation matrix T, the respective image processing system, for example the driver assistance system 3, in particular the reversing assistance 3a, may further process the image signal S1 output by the camera 2 and therefore exactly locate an acquired object and correspondingly provide assistance as a function thereof.

In order to improve the accuracy of the calibration, the number of markers 17 with the aid of which the transformation matrix T is ascertained should be selected to be correspondingly high, especially as some markers 17 may possibly also be obscured by fouling. By markers 17 on a plurality of air guide components 15, the calibration may in addition be plausibilized. Thus, a secure calibration may also still take place if one of the air guide components 15 is for example jammed or the applied markers 17 are obscured or fouled. The same applies for a subsequent alignment.

With the described method, an automated calibration of the rear-view camera 2 may thus be carried out simply and reliably (when appropriate with subsequent active adjusting of the camera 2 (alignment)), which is independent of the location of the vehicle 1 and, depending on the application and configuration, also independent of the driving situation of the vehicle 1. A driver is likewise not needed for this calibration, and when appropriate alignment, since it can take place in a fully automated fashion.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCES (PART OF THE DESCRIPTION)

1 vehicle
1a tractor
1b semitrailer
1c semitrailer rear
1d tractor rear
1e motor vehicle
1f motor vehicle rear
1g tail of the semitrailer 1b
2 rear-view camera
3 driver assistance system
3a reversing assistance
4 passenger compartment
5 monitor
10 calibrating arrangement
14 component
15 air guide component
15a lateral air guide flap
15b upper air guide flap
15c tail air guide flap
16 pivot arm
17 marker
19 processing unit
21 component actuator
23 camera actuator
A image
D deviation
E acquisition region
GW limit value
K1 cartesian coordinate system
M calibrating mode
P2 camera pose
P2Soll camera setpoint pose
PB17 image position of the markers 17
PM17 marker position of the markers 17
R rear space
S1 image signal
S2 overlay signal
S3 calibrating signal
S4 adjusting signal
S5 alignment signal
T transformation matrix
v1 vehicle speed
xA, xB image coordinates
xT, yT, zT transformed image coordinates
x17, y17, z17 marker coordinates
xK, yK, zK coordinates of the cartesian coordinate system K1
X setting of the component 14/air guide component 15
X1 first end setting (retracted, withdrawn)
X2 second end setting (deployed, extended)
XK calibration setting
XZ intermediate setting
ST0, ST1, St1.1, ST2, ST3, ST4, ST5, ST6, ST6.1, ST6.2, ST7 steps of the method

1. A method for calibrating a rear-view camera on a vehicle, having at least one component which can be adjusted,
wherein the at least one component can be adjusted into a calibration setting and at least one marker is arranged on the at least one component in such a way that the marker lies in an acquisition region of the rear-view camera after the at least one component has been adjusted into the calibration setting, and
wherein the rear-view camera is in a camera pose relative to the vehicle, the method comprising:
reading in image signals of the rear-view camera, the acquisition region of the rear-view camera being aimed at a rear space behind the vehicle such that the read image signals characterize an image of the rear space behind the vehicle, while the at least one component is in the calibration setting;
reading in at least one marker position, each read marker position being assigned to a respective marker of the at least one marker on a respective component of the at least one component, while the respective component is in the calibration setting;
ascertaining at least one image position as a function of the image signals, each ascertained image position being assigned to a respective marker on the respective component, while the respective component is in the calibration setting; and
calibrating the rear-view camera as a function of the read at least one marker position of a respective marker and the ascertained image position of the respective marker.

2. The method as claimed in claim 1, wherein a transformation matrix and/or the camera pose is ascertained from the marker position read in for the respective marker and the ascertained image position of the respective marker such that the image position of the respective marker is transformed by the transformation matrix and/or as a function of the camera pose onto the read marker position.

3. The method as claimed in claim 2, wherein the ascertained at least one image position of the respective marker is specified in image coordinates and the image coordinates of the respective marker are transformed as a function of the ascertained transformation matrix and/or the camera pose into transformed image coordinates in a cartesian coordinate system, the marker position of the respective marker likewise being specified in the cartesian coordinate system.

4. The method as claimed in claim 2, wherein a deviation between the camera pose of the rear-view camera and a prespecified camera setpoint pose is ascertained and the rear-view camera is aligned such that the deviation is reduced if a limit value for the deviation is exceeded, the deviation being compensated for.

5. The method as claimed in claim 4, wherein the alignment of the rear-view camera is carried out before the calibration of the rear-view camera.

6. The method as claimed in claim 4, wherein the rear-view camera is adjusted if the limit value is exceeded in order to make the ascertained camera pose approach the camera setpoint pose,
wherein an alignment signal is generated and output as a function of the ascertained deviation between the ascertained camera pose of the rear-view camera and the prespecified camera setpoint pose, and
wherein a camera actuator that cooperates with the rear-view camera is actuated with the alignment signal in such that the camera pose of the rear-view camera is adjusted.

7. The method as claimed in claim 1, wherein at least two components are provided, the at least two components being brought together or individually into the calibration setting for the calibration of the rear-view camera.

8. The method as claimed in claim 1, wherein the at least one component is at least one air guide which can be adjusted.

9. The method as claimed in claim 1, wherein the at least one component is configured to be adjusted continuously or in stages between a first end setting and a second end setting, the at least one component in the calibration setting being:
in an intermediate setting between the first end setting and the second end setting,
in the first end setting, or
in the second end setting.

10. The method as claimed in claim 1, wherein the at least one component can be brought into different calibration settings, each marker on this the at least one component being assigned a plurality of marker positions, each marker position being assigned to one of the different calibration settings so that the calibration of the rear-view camera can be carried out as a function of the read marker position of a marker for the respectively set calibration setting and the ascertained image position of the marker.

11. The method as claimed in claim 1, wherein the at least one component with the at least one marker can be adjusted in an automated fashion by a component actuator.

12. The method as claimed in claim 1, wherein before image signals of the rear-view camera are read in, a check is made as to whether a calibrating mode is activated and/or whether the at least one component is in the calibration setting.

13. The method as claimed in claim 12, wherein before image signals of the rear-view camera are read in, the at least one component is brought automatically into the calibration setting as soon as the calibrating mode is activated, or
wherein waiting is carried out until the at least one component is brought into the calibration setting by being adjusted into the calibration setting in an automated fashion as a function of a vehicle speed of the vehicle.

14. A vehicle having a calibrating arrangement and a rear-view camera, wherein the rear-view camera is in a camera pose relative to the vehicle, and wherein the calibrating arrangement comprises:
a processor which is configured to carry out the method as claimed in claim 1 for calibrating the rear-view camera, and
at least one component which is adjustable, the at least one component being configured for being adjusted into a calibration setting and at least one marker being arranged on the at least one component such that the marker lies in an acquisition region of the rear-view camera when the at least one component is adjusted into the calibration setting, the acquisition region of the rear-view camera being aimed at a rear space behind the vehicle.

15. The vehicle as claimed in claim 14, wherein the vehicle comprises a single section including a motor vehicle, or comprises multiple sections, including a tractor and a semitrailer.

16. The vehicle as claimed in claim 15, wherein the rear-view camera is arranged on a semitrailer rear of the semitrailer of the tractor or on a motor vehicle rear of the motor vehicle.

17. The vehicle as claimed in claim 14, wherein the at least one component is at least one air guide which can be adjusted and can be brought together or respectively individually into the calibration setting.

18. The vehicle as claimed in claim 14, wherein the at least one component can be adjusted in an automated fashion by a component actuator.

19. The vehicle as claimed in claim 14, further comprising a driver assistance system, the driver assistance system being configured to read in and process the image signals of the calibrated rear-view camera.

20. The vehicle as claimed in claim 8, wherein the at least one air guide is one or more of a lateral air guide flap, an upper air guide flap, and a tail air guide flap.
